(19) United States
(12) Patent Application Publication
(10) Pub. No.: US 2022/0348169 A1
(43) Pub. Date: Nov. 3, 2022

(54) Vehicle Washing Device

(71) Applicant: Danilo C. Foz, Martinez, CA (US)

(72) Inventor: Danilo C. Foz, Martinez, CA (US)

(21) Appl. No.: 17/244,536

(22) Filed: Apr. 29, 2021

(51) Int. Cl. B60S 3/04

(52) U.S. Cl. CPC B60S 3/044

(57) ABSTRACT

A self-contained washing device for vehicles and other uses that compactly combines the necessary washing components including a pressure pump, extension hose, pressure wand, soap holder and rechargeable battery into an integrated assembly that can be attached to a standard open topped bucket mounted to a rolling retaining platform enabling the user to wash a vehicle at a location that may be distant from a standard pressurized water supply.

### CROSS REFERENCE TO RELATED APPLICATIONS

Not Applicable.

### STATEMENT REGARDING FEDERALLY SPONSORED RESEARCH OR DEVELOPMENT

Not Applicable

### DESCRIPTION OF ATTACHED APPENDIX

Not Applicable.

### BACKGROUND OF THE INVENTION

This invention relates generally to the field of vehicle washing devices and more particularly to a coordinated collection of components that can be added to a standard open topped bucket to create a self-contained washing system. Currently, if a person wants to wash his or her vehicle, they must have access to a pressurized water supply, normally the outdoor spigot found on an outer wall of most single family homes. However, people living in apartments or condominiums do not have easy access to a pressurized water supply and must wash their vehicles in a parking lot or parking space on the street. There is therefore a need to make available a unique and compact coordinated set of components that allow for the pressurized washing of a vehicle in a location not in close proximity to an outdoor pressurized water spigot.

### BRIEF SUMMARY OF THE INSTANT INVENTION

The primary object of the invention is to provide a unique vehicle washing device that includes a rolling bucket supporting frame, a pressure pump and associated hose, battery, and pressure washing wand to create a self-contained washing system enabling a user to wash a vehicle independent of a nearby water source.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a self-contained washing device that provides a rolling retaining frame for a standard open topped, typically five gallon size, bucket, an open topped secondary container shaped to fit alongside of said bucket, a pressure pump, a rechargeable battery, a pressure washing wand, a first flexible water tube and a second flexible water tube wherein the open topped container comprises a first water tube holding member, an inverted U shaped member for holding the open topped secondary container to the top edge of the standard open topped bucket and a retaining socket for a rechargeable battery, the second water flexible tube extending from the bottom of the inside of the standard open topped bucket to the intake port of a pressure pump, the first flexible tube extending from the exit port of the pressure pump to the inlet port of the pressure washing wand, the entire assembly capable of pressure washing a vehicle without need of a separate water supply. A five gallon bucket size appears to be an optimal size for this application.

### BRIEF DESCRIPTION OF THE DRAWINGS

The drawings constitute a part of this specification and include exemplary embodiments to the instant invention, which may be embodied in various forms. It is to be understood that in some instances various aspects of the instant embodiments may be shown exaggerated or enlarged to facilitate an understanding of the instant embodiment.

FIG. 1 is a perspective view of the embodiment.

FIG. 2 is an exploded view of the embodiment showing the secondary container removed from the bucket.

FIG. 3 is a perspective view of the embodiment showing the inverted U shaped holding member that holds the secondary container to the bucket.

FIG. 4 is an exploded view showing the container removed from the rolling retaining frame.

FIG. 5 is a partial section view showing the pressure washing wand stored within the secondary container.

FIG. 6 is a perspective view of the embodiment with the pressure washing wand removed from the secondary container.

FIG. 7 is a perspective view of the embodiment showing the rechargeable battery about to be inserted into its receiving socket.

FIG. 8 is a side section view showing the location of the battery in relation to the secondary container.

### DETAILED DESCRIPTION OF THE PREFERRED EMBODIMENTS

Detailed descriptions of the preferred embodiment are provided herein. It is to be understood, however, that the present embodiment may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

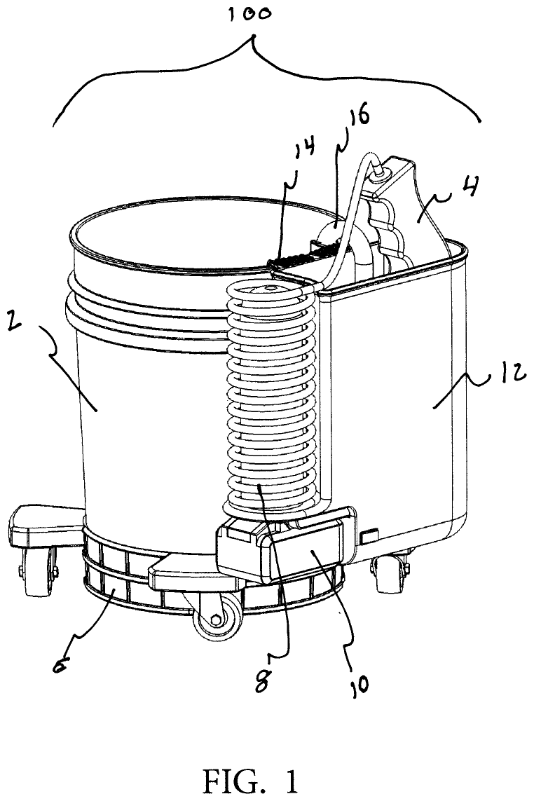

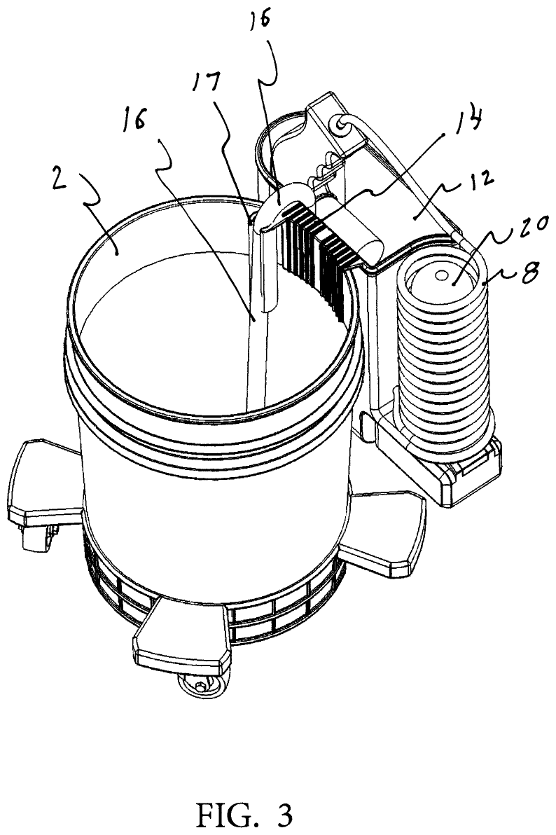

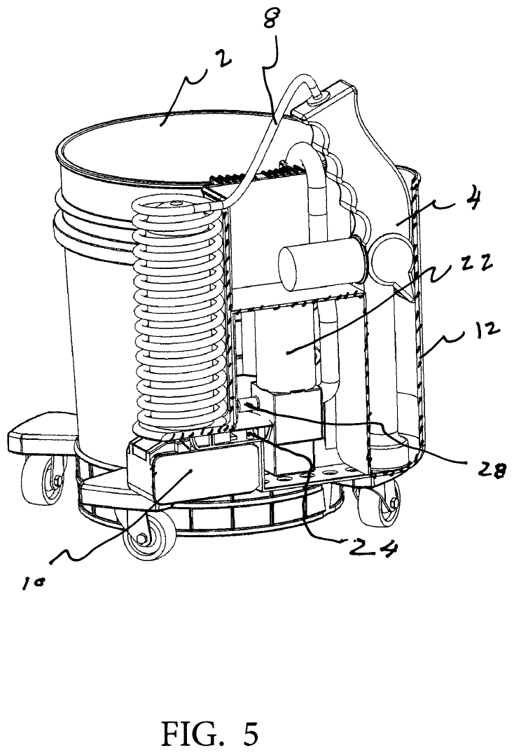

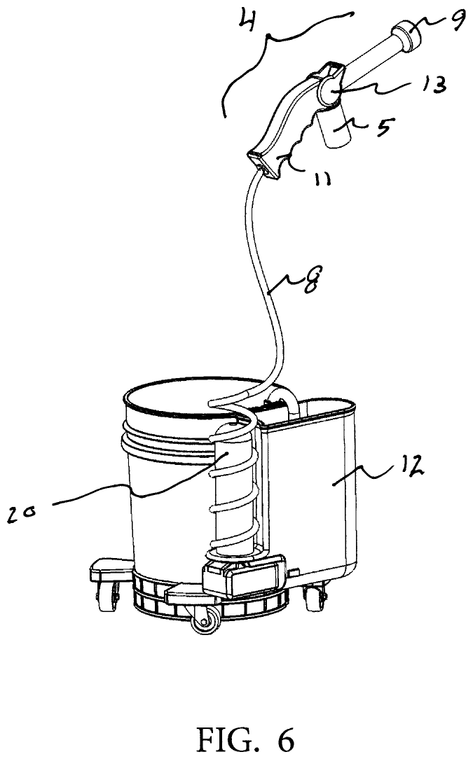

Referring now to FIG. 1 we see a perspective view of the embodiment 100. A rolling retaining frame 6 retains a standard bucket 2, typically a five gallon. A secondary open topped container 12 is removably attached to the bucket via inverted U shaped member 14 which is integrally molded onto the side of secondary container 12. The secondary container includes an upwardly directed post 20, shown clearly in FIGS. 3 and 6. This post 20 removably retains a reticulated first water tube 8. The water tube 8 is attached at one end to a pressure pump 22 outlet port shown in FIG. 5 and at the other end to a pressure washing wand 4 inlet port. A second water tube 16 is attached at one end to the inlet port of pressure pump 22 and the opposite end terminates at the lower portion of bucket 6 where it can draw in water stored within the bucket 6. A rechargeable battery 10 is removably attached to a connector 24 shown in FIG. 5 and powers the pressure pump 22.

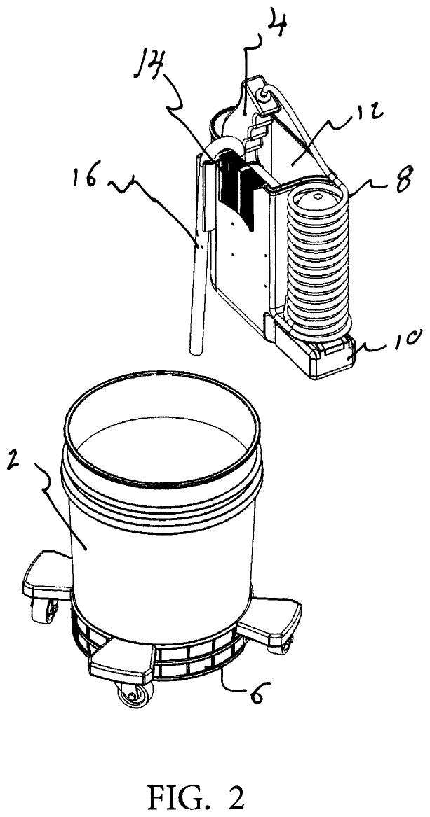

FIG. 2 shows the open topped container 12 removed from the edge of the bucket 2. The inverted U-shaped member 14 is shown as the device that helps the secondary container 12 be held onto the bucket 2. The second tube 16 length is such that the exposed end of the second tube 16 is located near the bottom of bucket 2 when secondary container 12 is secured onto the side of the bucket 2.

FIG. 3 is a perspective view of the embodiment looking further down into the bucket 2. This view shows the top of post 20 which removably retains first hose 8. Inverted U shaped retaining member 14 includes a C shaped retaining sleeve that directs flexible second tube 16 into the bucket 2.

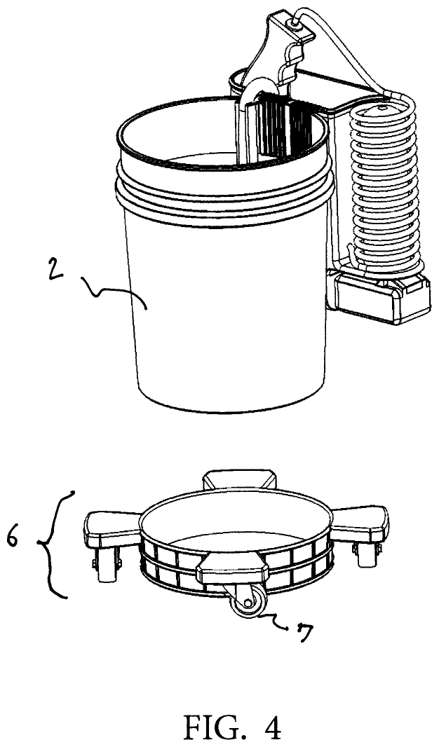

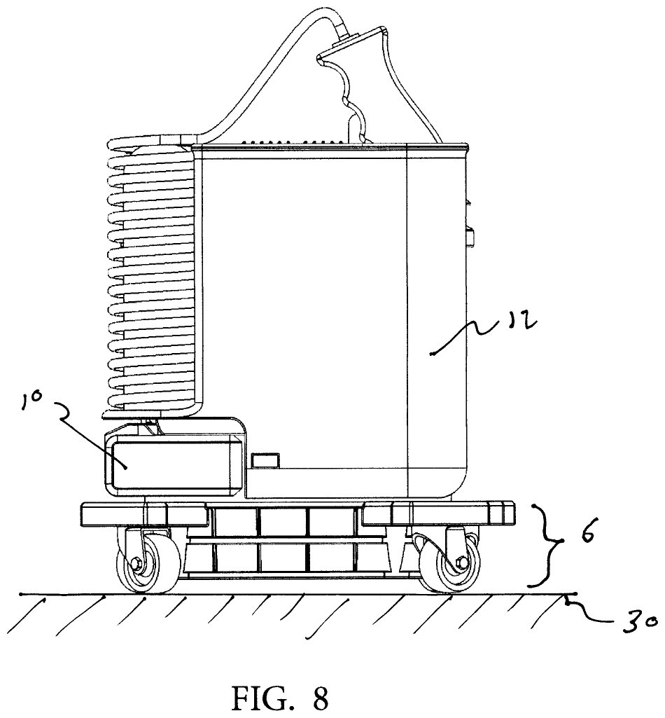

FIG. 4 is an exploded view showing the bucket removed from rolling retaining frame 6 the bucket is frictionally held in place on the inner wall of the rolling retaining frame 6. Wheels 7 are swivel type and allow the bucket to be rolled easily in any direction. The bucket holding retaining frame 6 is held in close proximity to the ground as shown in FIG. 8 thereby reducing the possibility of the bucket 2 from falling over when it is rolled from one location to another.

FIG. 5 is a section view of the embodiment clearly showing pressure pump 22 as it is held in place within a cavity molded into secondary container 12. Pump 22 can pump pressurized water and or soap, typically with approximately one hundred pounds per square inch of pressure which is significantly higher than the water pressure of a typical home which is approximately fifty pounds per square inch. Therefore, even single family home owners with access to an outside spigot will benefit from the higher pressure washing feature of the present embodiment. First flexible tube 8 is attached to the outlet port 28 of pump 22. A battery 10 is removably plugged in to a battery receiving socket 24. Battery 10 can be removed and recharged in a standard charging station that is plugged into a standard AC wall socket or extension cord.

FIG. 6 is a perspective view where pressure washing wand 4 is removed from secondary container 12. The pressure wand 4 includes a handle 11, a selector knob 13, a soap container 5 and an exit port 9. A user can rotate the selector knob 13 from an off position to either a wash position or a soap position. The wash position allows high pressure water to be sprayed on a vehicle. The soap position allows soap stored in housing 5 to be mixed with water via the venturi principle so that a combination of soap and water are expelled out of the exit port 9 creating a soap foaming effect that is ideal for cleaning a vehicle. By rotating the knob 13 from the off position to either the soap or wash position, the pump 22 is automatically turned on by a pressure switch built into the pump 22. The exit port 9 is also rotatable thereby allowing a selection a variety of spray patterns from narrow to wide.

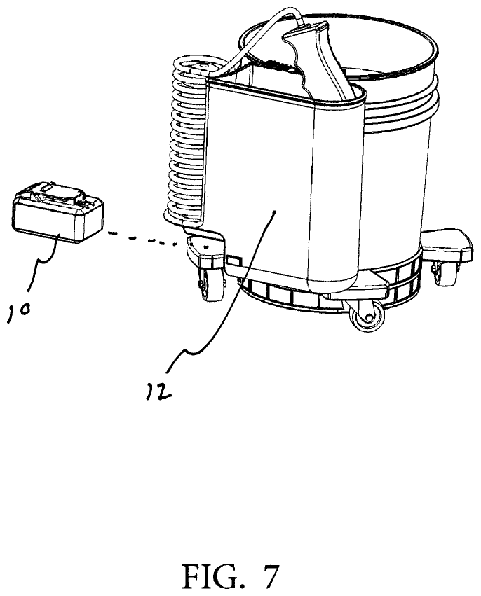

FIG. 7 is a perspective view showing battery 10 about to be plugged into its receiving socket 24 as shown in FIG. 5.

FIG. 8 is a side view that shows that the low slung nature of bucket retaining frame 6 makes it so that the bottom of bucket 2 is in close proximity to the ground 30 thereby making the entire device stable and not prone to tipping over when a user pulls on bucket 2.

It is understood that the present embodiment 100 can be used for other washing activities such as the cleaning of the outer surface of windows in a home or office.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

In the claims, the word “comprising” does not exclude the presence of other elements or steps then those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are arbitrarily used to distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

What is claimed is:

1. A self-contained vehicle washing device configured to wash a vehicle without needing to be in close proximity to an external pressurized water source arranged in a manner allowing for a small overall size allowing for compact storage and shipping, comprised of:
a rolling retaining frame;
an open topped bucket rollingly retained by the rolling retaining frame;
a pressure pump comprising an inlet port and an outlet port;
a first flexible tube, comprising a first end and a second end;
a second flexible tube, comprising a first end and a second end;
an open topped secondary container being suspended on the outside surface of the open topped bucket by an inverted U-shaped retaining member comprising an internal cavity for retaining the pressure pump;
a rechargeable battery removably retained by a battery receiving socket located on the underside of the open topped secondary container;
a pressure washing wand comprising an inlet port and an outlet port;
the first end of the first flexible water tube being attached to the outlet port of the pressure pump and at the second end to the inlet port of the pressure wand; and
the first end of the second flexible water tube being attached to the inlet port of the pressure pump and the second end of the second flexible water tube being in close proximity to the bottom of the open topped bucket.

2. A self-contained vehicle washing device as claimed in claim 1 wherein the open topped bucket bottom is retained by the rolling retaining frame in close proximity to the ground in a manner allowing the self-contained vehicle washing device to roll freely.

3. A self-contained vehicle washing device as claimed in claim 1 wherein the secondary open topped container further comprises a post molded on the outside of the open topped secondary container and wherein furthermore the first flexible tube is reticulated and can be removably retained on the post molded onto the side of the secondary open topped container.

4. A self-contained vehicle washing device as claimed in claim 1 wherein the pressure washing wand further comprises a soap holder, a handle comprising the inlet port and a knob selector located between the handle and the outlet port, wherein the knob selector enables a user to choose clean water or water mixed with soap to be discharged from the pressure washing wand outlet port.

5. A self-contained vehicle washing device as claimed in claim 1 wherein the open topped bucket size is approximately five gallons.
